(19) United States
(12) Patent Application Publication
(10) Pub. No.: US 2006/0150897 A1
(43) Pub. Date: Jul. 13, 2006

(54) Wear resistant coating blade or a corresponding blade for the treatment of a paper web

(75) Inventor: Ingmar Vesterlund, Pyhajoki (FI)

Correspondence Address: VOLPE AND KOENIG, P.C., UNITED PLAZA, SUITE 1600, 30 SOUTH 17TH STREET, PHILADELPHIA, PA, 19103, US

(73) Assignee: DIAMOND BLADE OY, Parhalahti (FI)

(21) Appl. No.: 10/531,927

(22) PCT Filed: Oct. 21, 2003
(86) PCT No.: PCT/FI03/00781

§ 371 Date: Dec. 6, 2005

(30) Foreign Application Priority Data
Oct. 22, 2002 (FI) 20021883

(51) Int. Cl. B05C 11/02; B05C 1/00; B05C 1/08

(52) U.S. Cl. 118/100; 118/200; 118/261

(57) ABSTRACT

A treatment blade (4), such as a coating, doctor or creping blade, designated for the treatment of a paper web and provided with a wear resistant coating (42), in which blade the area to be coated has been roughened before the coating process. The roughening traces (43) are perpendicular to the longitudinal direction of the treatment blade.

The present invention relates to a treatment blade, such as a coating, doctor or creping blade, designed for the treatment of a paper web and provided with a wear resistant coating.

In a paper coating process, the paper is generally coated with a paste-like additive containing e.g. a pigment and binding agents. The objective of coating is to improve the properties of the surface of the paper. Coating takes place in the coating unit of a paper machine, where a coating material is spread on the surface of raw paper and smoothed. The coating process may take place e.g. in a blade coater, where the coating material is spread on the surface of the paper and smoothed by means of a coating roller and a coating blade arranged in conjunction with it. The coating blade edge facing towards the paper web is beveled. To increase the wear resistance of coating blades, the coating blade edge adjacent to the paper web is coated with a wear resistant material, such as a ceramic material. By using a coated blade, a longer service life, fewer blade changes, less culled paper and more paper of a better quality is produced in the same machine time.

Before the coating operation, the area to be coated often has to be pretreated to improve the adhesion of the coating material. Therefore, the blade has to be provided with an expensive adhesion layer coating e.g. by the plasma coating (APS) method, which produces a layer thickness of about 20-30 μm. The adhesion layer coating is made before the actual wear resistant coating. The wear resistant coating can be produced e.g. by the plasma spraying (APS) technique to cause the ceramic coating to melt without applying too much heat to the surface of the blade.

A scraper blade provided with a wear resistant coating is disclosed in specification GB-A-2 128 551. The coating process is implemented using ceramic materials, metal oxides or carbides. The coating comprises a number of layers one upon the other. Before being coated, a carrier material strip is pretreated e.g. by grain-blasting it with carborundum powder.

The coating of the blade is typically performed on a straight strip of a length of 3-12 m, and consequently the coating time is long. The coating spray must sweep the area to be coated many times, typically 10-500 times, to obtain a coating of desired thickness (200-350 μm). The adhesion layer coating and the long back-and-forth coating movement lead to a long coating time and an expensive coating.

The problem with the prior-art technique is that the coating will split and crack especially when the blades are being mounted, which involves bending of the blades, and during transportation, the blades being wound as rolls for transportation. Therefore, the rolled-up blades are subjected to a relatively strong force effect caused by the bending, with the result that the coating of the blade is easily detached or damaged.

The object of the present invention is to overcome the drawbacks of prior art and achieve a new type of blade designed for the treatment of a paper web and provided with a wear resistant coating, in which blade the coated area has been roughened before the coating process. According to the invention, the roughening is such that the grinding traces extend in the running direction of the paper web, i.e. transversely to the longitudinal direction of the coating blade.

The blade to be coated is coarsened to a relatively high degree of roughness, about 3-6 μm Ra, ensuring that the hard metal affixed onto the blade will stick fast on the blade surface in all stress conditions. The invention allows the surface roughness required for adherence of the coating to be achieved without deformation of the thin blade.

The features of the blade of the invention are presented in detail in the claims below.

The coating blade of the invention is very well able to withstand various types of handling, such as e.g. bending occurring during installation and transportation, without the coating being detached or damaged. In addition, the coating arrangement of the invention is simple and economical.

In the following, the invention will be described in detail by means of an example with reference to the attached drawings, wherein

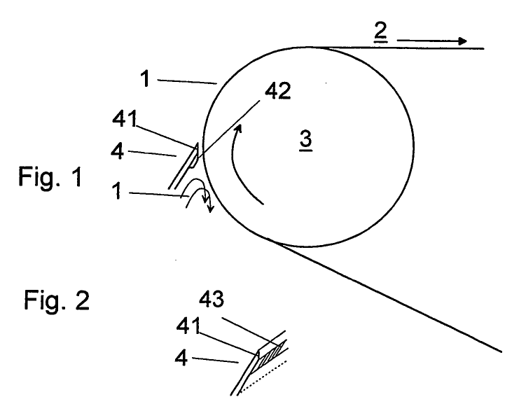

FIG. 1 presents a coating blade produced by an apparatus according to the invention, fitted in conjunction with a coating roller,

FIG. 2 presents a coating blade which has been ground before being coated, and

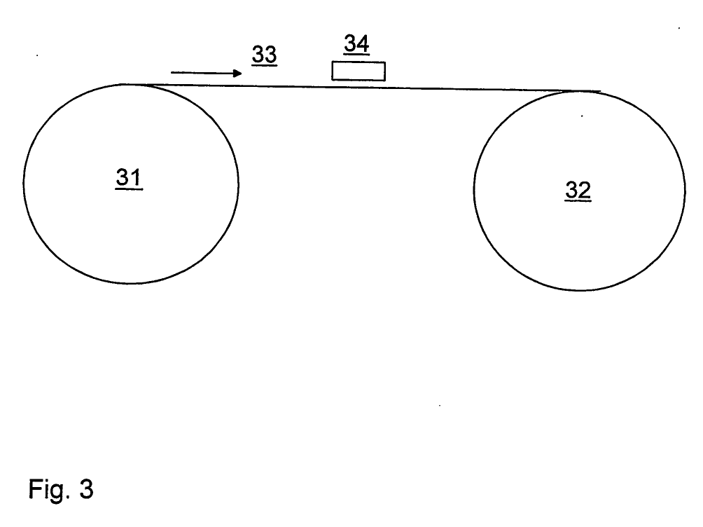

FIG. 3 presents an apparatus according to the invention for making a coating blade.

FIG. 1 presents a blade designed for coating paper in a coater, in which a coating material 1 is applied to the surface of a paper web 2 running between rollers and smoothed by means of a coating roller 3 rotated in the direction indicated by the arrow and a coating blade 4 arranged in conjunction with it. The coating blade edge 41 facing towards the paper web 2 is beveled. To improve the wear resistance of coating blades, the coating blade edge 41 facing towards the paper web is coated in the direction of web entry with a wear resistant coating 42.

The wear resistant coating 42 may consist of a hard metal, e.g. wolfram carbide, chrome carbide, titan carbide, titan oxide, or aluminum oxide, Al₂O₃ possibly containing additives, such as titan oxide TiO₂.

The roughening of the adhesion surface of the edge coating is implemented by grinding so that the grinding traces 43 are perpendicular to the longitudinal direction of the coating blade. In addition, the blade to be coated is roughened to about 3-6 μm Ra, so the area to be coated will be relatively rough and the coating to be affixed onto the blade will adhere securely to the blade surface in all stress conditions.

According to the invention, the wear resistant coating is produced by a new coating technique according to the invention from a HVOF reel by using an apparatus as illustrated in FIG. 3, through the following steps:

1. Preliminary preparation of the blade, roughening. The surface of the blade 4 to be coated needs to be roughened to about 5-6 μm Ra to ensure that the hard metal 42 to be affixed onto the blade will remain fixed to the blade surface in all stress conditions. Roughening the surface by the traditional grain-blasting method is not applicable because the blade would bend by the modification produced by the grain blasting. By grinding with a rough band or stone 34, it is possible to give the hardened blade preform a surface roughness of about Ra 2-6 μm, which is required for a thermally sprayed coating. The surface roughness required for affixation of the coating is achieved without deformation of the thin blade. The grinding can be performed as a reel-to-reel 31, 32 grinding process, wherein the coating operation is accomplished by winding a coating strip 33 around a cylinder in several layers and the blade material is wound on the coating cylinder in an overlapping manner so that the previous layer protects the surface not to be roughened. After the roughening, the blade preform is wound around a coating drum and is ready to be coated.

2. Coating the blade on a rotating drum: There are several reasons for implementing the coating operation by winding the blade around a rotating drum ( d =1 m, l=2 m). A blade strip 33 having a width of 50-100 mm is wound around the rotating drum in a spiral with a pitch of about 5-12 mm. With the strip wound in this way, it is easy to define a blade edge area of 5-12 mm to be coated. The next lap naturally delimits the area to be coated. When the blade is wound in a spiral over the drum, it is possible to produce 50-600 m of finished coated blade in a single operation. The blade is coated by the HVOF method. The coating drum is rotated at a circumferential speed of 1-10 m/s while the surface of the blades on the drum is swept by a coating spray.

This is not possible in traditional technology, by spreading the blades to be coated on a flat surface. Coating the blade on a rotating drum guarantees sufficient cooling of the thin blade, which is easily distorted by heat.

It is obvious to the person skilled in the art that different embodiments of the invention are not limited to the example described above, but that they may be varied within the scope of the claims presented below. In addition to a coating blade, the invention can be applied in the case of other blades for the treatment of a paper web, such as doctor and creping blades.

1. Treatment blade (4), such as a coating, doctor or creping blade, designed for the treatment of a paper web and provided with a wear resistant coating (42), in which blade the area to be coated has been roughened before the coating process, characterized in that the roughening traces (43) are perpendicular to the longitudinal direction of the treatment blade.

2. Blade according to claim 1, characterized in that the area to be coated has been roughened to the range of 3-6 μm Ra.

3. Blade according to claim 1, characterized in that the roughening has been formed by grinding the blade surface.
